(19) United States
(12) Patent Application Publication
(10) Pub. No.: US 2021/0154641 A1
(43) Pub. Date: May 27, 2021

(54) SORBENT FOR AT LEAST ONE METAL

(71) Applicant: SOLENIS TECHNOLOGIES, L.P., Wilmington, DE (US)

(72) Inventors: Sharad Mathur, Brooklyn, NY (US); Charles Elliott Cleary, Jr., Ivey, GA (US); Michael Bluemle, Wilmington, DE (US)

(73) Assignee: SOLENIS TECHNOLOGIES, L.P., Wilmington, DE (US)

(21) Appl. No.: 16/697,429

(22) Filed: Nov. 27, 2019

(51) Int. Cl. B01J 20/08; B01J 20/16; C02F 1/28

(52) U.S. Cl. CPC B01J 20/08; C02F 1/281; B01J 20/16

(57) ABSTRACT

This disclosure provides a sorbent for at least one metal. The sorbent includes a core particle and a ceramic nanoparticulate cation exchanger for at least one metal that is disposed about the core particle. The core particle is chosen from titanium dioxide, alumina, iron oxide, and combinations thereof.

### TECHNICAL FIELD

The present disclosure generally relates to a sorbent for at least one metal. More specifically, the present disclosure relates to a sorbent that includes a core particle and a ceramic nanoparticulate cation exchanger disposed about the core particle.

### BACKGROUND

Exposure to toxic metals continues to be a major occupational and environmental problem around the world. Exposure occurs through environmental sources of contaminated food, water and air. The most common acute and/or chronic metal toxicities tend to be related to lead, arsenic, and mercury. However, other metals can be problematic as well.

Drinking water remains a major source of heavy metal exposure and is responsible for about 20 percent of the total daily exposure by the majority of the US population. Ultrafiltration and reverse osmosis treatments produce high-quality water, but they are slow and the associated equipment and supplies are expensive. Another approach to this problem has been to use high surface area nanomaterials that actively absorb contaminants but do not restrict flow like membranes. Boehmite nanofibers that are 2 nanometers wide and 100 nanometer exhibit surface areas as high as 600 m²/g. Filters fabricated from these fibers remove bacteria, viruses and endotoxins from water by irreversibly binding the pathogens or toxins. However, these filters also non-selectively remove a variety of metal ions and ion mixtures from water that are beneficial. Accordingly, there remains an opportunity for improvement. Many desirable features and characteristics of the present disclosure will become apparent from the subsequent detailed description of the disclosure and the appended claims, taken in conjunction with this background of the disclosure.

### BRIEF SUMMARY

This disclosure provides a sorbent for at least one metal. The sorbent includes a core particle and a ceramic nanoparticulate cation exchanger for at least one metal that is disposed about the core particle. The core particle is chosen from titanium dioxide, alumina, iron oxide, and combinations thereof.

This disclosure also provides a method of forming the sorbent. The method includes providing a dispersion of the core particle and the ceramic nanoparticulate cation exchanger for at least one metal in water. The method also includes the step of spray drying the dispersion to form the sorbent, wherein the dispersion has a pH of greater than about 9.5.

This disclosure further provides a water treatment device that includes the sorbent and a method of treating water that includes at least one metal wherein the method includes the step of contacting the water with the sorbent. This method may utilize the aforementioned water treatment device.

### DETAILED DESCRIPTION

The following detailed description is merely exemplary in nature and is not intended to limit the instant sorbent. Furthermore, there is no intention to be bound by any theory presented in the preceding background or the following detailed description. Embodiments of the present disclosure are generally directed to sorbents and methods for fabricating the same. For the sake of brevity, conventional techniques related to sorbent architecture and methods of formation may not be described in detail herein. Moreover, the various tasks and process steps described herein may be incorporated into a more comprehensive procedure or process having additional steps or functionality not described in detail herein. In particular, various steps in the manufacture of sorbents are well-known and so, in the interest of brevity, many conventional steps will only be mentioned briefly herein or will be omitted entirely without providing the well-known process details.

This disclosure provides a sorbent for at least one metal. The terminology “sorbent” is known in the art and typically describes a substance or particle that “adsorbs” or “absorbs” a targeted substance from a liquid or a gas. The sorbent can act by surface sorption or bulk sorption. Typically, the sorbent of this disclosure adsorbs at least one metal from a liquid such as water.

The at least one metal is not particularly limited and may be further defined as at least one heavy metal or a non-heavy metal or a combination of at least one heavy metal and at least one non-heavy metal. In various embodiments, the term heavy metal refers to any metallic chemical element that has a relatively high density and is toxic or poisonous at low concentrations. Non-limiting examples of heavy metals include mercury (Hg), cadmium (Cd), arsenic (As), chromium (Cr), thallium (Tl), and lead (Pb). In other embodiments, heavy metals can include chromium, arsenic, cadmium, mercury, and lead, along with manganese, cobalt, nickel, copper, zinc, selenium, silver, tin, antimony and/or thallium. Most commonly, the at least one metal is lead and/or mercury. Alternatively, the metal may be selenium and/or arsenic. The choice of non-heavy metal may be any metal of the periodic table.

### Core Particle:

The sorbent includes a core particle. The core particle is chosen from titanium dioxide, alumina, iron oxide, and combinations thereof. Accordingly, the core particle can be titanium dioxide or alumina or iron oxide or a combination of both titanium dioxide and alumina or a combination of titanium dioxide and iron oxide, or a combination of alumina and iron oxide, or a combination of titanium dioxide, alumina, and iron oxide. If a combination is utilized, the weights of the titanium dioxide and the alumina and iron oxide are not limited and one or more may independently be present in an amount of from about 0.1 to about 99.9 wt %, respectively, such that a total is 100 wt %. In various embodiments, the weights of the titanium dioxide, alumina, and/or iron oxide may each independently be about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, or about 50, weight percent, such that a total is 100 weight percent. It is contemplated that the titanium dioxide may be used to the exclusion of the alumina and/or the iron oxide. Similarly, the alumina may be used to the exclusion of the titanium dioxide and/or the iron oxide. Moreover, the iron oxide may be used to the exclusion of the titanium dioxide and/or the alumina. In various non-limiting embodiments, all values and ranges of values, both whole and fractional, between and including those set forth above, are hereby expressly contemplated for use herein.

The titanium dioxide and/or the alumina and/or the iron oxide. may be any that is commercially available or known in the art. For example, the titanium dioxide may be in any form such as rutile, anatase, akaogiite, brookite, monoclinic, tetragonal, orthorombic, α-PbO₂-like, baddeleyite-like, cotunnite-like, orthorhombic OI, or cubic phase.

The alumina can also be of any type. Alumina is also known as aluminium oxide (IUPAC name) or aluminum oxide and has the formula Al₂O₃. It is the most commonly occurring of several aluminum oxides, and specifically identified as aluminum(III) oxide. It is commonly called alumina and may also be called aloxide, aloxite, or alundum depending on particular forms or applications. It occurs naturally in its crystalline polymorphic phase as the mineral corundum.

The iron oxide can also be of any type. In various embodiments, the iron oxide is chosen from FeO (iron(II) oxide, wüstite), FeO₂ (iron dioxide), mixed oxides of Fe(II) and Fe(III) such as Fe3O4 (Iron(II,III) oxide, magnetite), Fe₄O₅, Fe₅O₆, Fe₅O₇, Fe₂₅O₃₂, Fe₁₃O₁₉, Oxides of Fe(III) such as Fe₂O₃ (iron(III) oxide), α-Fe₂O₃ (alpha phase, hematite), β-Fe₂O₃ (beta phase), γ-Fe₂O₃ (gamma phase, maghemite), ε-Fe₂O₃ (epsilon phase), and combinations thereof.

The core particle is not particularly limited in particle size. In various embodiments, the core particle has a particle size of from about 1 to about 200 micrometers, e.g. as determined using laser diffraction (such as using a Malvern Mastersizer and methods known in the art). Alternatively, the core particle may have a D10, D50, and/or D90, each of which is independently of from about 1 to about 200 micrometers. In one embodiment, the core particle is alumina having a D10 value of from about 4 to about 10, a D50 value of from about 10 to about 16, and a D90 value of from about 20 to about 42, micrometers, each determined using laser diffraction. It is contemplated that any one or more of the aforementioned values may independently be about 1 to about 200, about 5 to about 195, about 10 to about 190, about 15 to about 185, about 20 to about 180, about 25 to about 175, about 30 to about 170, about 35 to about 165, about 40 to about 160, about 45 to about 155, about 50 to about 150, about 55 to about 145, about 60 to about 140, about 65 to about 135, about 70 to about 130, about 75 to about 125, about 80 to about 120, about 85 to about 115, about 90 to about 110, about 95 to about 105, or about 100 to about 105, micrometers. In various non-limiting embodiments, all values and ranges of values, both whole and fractional, between and including those set forth above, are hereby expressly contemplated for use herein.

In another embodiment, the core particle has:

a D10 value of from about 4 to about 10, about 5 to about 9, about 6 to about 8, or about 7 to about 8, micrometers, as determined using laser diffraction;

a D50 value of from about 10 to about 16, about 11 to about 15, about 12 to about 14, or about 13 to about 14, micrometers, as determined using laser diffraction; and

a D90 value of from about 20 to about 42, about 21 to about 41, about 22 to about 40, about 23 to about 39, about 24 to about 38, about 25 to about 37, about 26 to about 36, about 27 to about 35, about 28 to about 34, about 29 to about 33, about 30 to about 32, or about 31 to about 32, micrometers, as determined using laser diffraction. In various non-limiting embodiments, all values and ranges of values, both whole and fractional, between and including those set forth above, are hereby expressly contemplated for use herein.

### Ceramic Nanoparticulate Cation Exchanger

The disclosure also provides a ceramic nanoparticulate cation exchanger for at least one metal that is disposed about the core particle. It is to be understood that the terminology “disposed about” encompasses both partial and complete covering of the core particle by the ceramic nanoparticulate cation exchanger.

The cation exchanger can be alternatively described as a nanocage ceramic with a high selective capacity for removal of a metal such as lead, mercury and cadmium or other heavy metals from aqueous media. The cation exchanger can be alternatively described as a nanoparticulate ceramic with a high specificity for heavy metal ligands, wherein these are removed even in the presence of competing ions such as calcium and magnesium. Thus, there is typically little interference from ions frequently found in hard water, for example. The binding of heavy metals can be considered to be essentially irreversible. This prohibits the future release and exposure to the host or environment. The cation exchanger can alternatively be alternatively described as a nanocage ceramic with a high selective capacity for removal of a non-heavy metal such as any described above.

In one embodiment, the ceramic nanoparticulate cation exchanger is chosen from aluminosilicates, titanosilicates, and combinations thereof. An aluminosilicate is a silicate compound or network in which some silica tetrahedra are replaced by aluminum octahedra. A titanosilicate is a silicate compound or network in which some silica tetrahedra are replaced by titanium octahedra. Any aluminosilicate and/or titanosilicate known in the art can be used herein.

In one embodiment, the ceramic nanoparticulate cation exchanger is amorphous titanosilicate (ATS). The ATS is not particularly limited and may be any commercially available or known in the art. In another embodiment, the ceramic nanoparticulate cation exchanger is crystalline titanosilicate. In still another embodiment, the ceramic nanoparticulate cation exchanger is a combination of amorphous titanosilicate (ATS) and crystalline titanosilicate.

The ceramic nanoparticulate cation exchanger may alternatively be any as described in one of more of U.S. Pat. Nos. 4,938,939; 5,053,139; 5,989,434; 6,340,433; 9,744,518; or 9,764,315 or WO2017015318, each of which is expressly incorporated in its entirety by reference herein in various non-limiting embodiments.

The weight percent of the core particle and the ceramic nanoparticulate cation exchanger typically sums to about 100 wt %. However, other optional additives such as gelling agents, thickening agents, and beneficial compounds including chelators and the like can also be used, e.g. in amount of from zero to up to about 5 wt % of the total 100%, or any value or range of values therebetween. In other words, if one of these optional additives is utilized, the weight percent of the core particle and the ceramic nanoparticulate cation exchanger will sum to less than 100% and the remainder will be the weight percent of the optional additive. In various embodiments, the optional additive is as described in U.S. Pat. No. 8,883,216, which is expressly incorporated herein by reference in its entirety in various non-limiting embodiments.

It is contemplated that the sorbent may be, include, consist essentially of, or consists of, the core particle and the ceramic nanoparticulate cation exchanger for at least one metal that is disposed about the core particle. The terminology “consist essentially of” can describe various embodiments that are free of core particles that are not those described herein and/or free of cationic/anionic/non-ionic compounds that absorb or adsorb metals, as would be understood by those of skill in the art. The terminology “consist essentially of” can alternatively describe various embodiments that are free of core particles that are not titanium dioxide and/or alumina and/or combinations thereof. For example, the core particle may include titanium dioxide and be free of alumina or may include alumina and be free of titanium dioxide. Moreover, it is also contemplated that, in various embodiments, the sorbent may be free of any one or more optional components described herein. The terminology “free of” typically describes embodiments that include less than 5, 4, 3, 2, 1, 0.5, 0.1, 0.05, or 0.01, weight percent of the compound at issued based on a total weight of the sorbent.

### Various Weight Percent Embodiments

In one embodiment, the core particle is present in an amount of from about 5 to about 95 weight percent based on a total weight percent of the sorbent and the ceramic nanoparticulate cation exchanger is present in an amount of from about 95 to about 5 weight percent based on a total weight percent of the sorbent. In another embodiment, the core particle is present in an amount of from about 10 to about 90 weight percent based on a total weight percent of the sorbent and the ceramic nanoparticulate cation exchanger is present in an amount of from about 90 to about 10 weight percent based on a total weight percent of the sorbent. In another embodiment, the core particle is present in an amount of from about 20 to about 80 weight percent based on a total weight percent of the sorbent and the ceramic nanoparticulate cation exchanger is present in an amount of from about 80 to about 20 weight percent based on a total weight percent of the sorbent. In another embodiment, the core particle is present in an amount of from about 30 to about 70 weight percent based on a total weight percent of the sorbent and the ceramic nanoparticulate cation exchanger is present in an amount of from about 70 to about 30 weight percent based on a total weight percent of the sorbent. In a further embodiment, the core particle is present in an amount of from about 40 to about 60 weight percent based on a total weight percent of the sorbent and the ceramic nanoparticulate cation exchanger is present in an amount of from about 60 to about 40 weight percent based on a total weight percent of the sorbent. In another embodiment, the core particle is present in an amount of about 50 weight percent based on a total weight percent of the sorbent and the ceramic nanoparticulate cation exchanger is present in an amount of about 50 weight percent based on a total weight percent of the sorbent. In various non-limiting embodiments, all values and ranges of values, both whole and fractional, between and including those set forth above, are hereby expressly contemplated for use herein.

In one embodiment, the core particle is alumina having a D10 value of from about 4 to about 10, a D50 value of from about 10 to about 16, and a D90 value of from about 20 to about 42, micrometers, each determined using laser diffraction, the ceramic nanoparticulate cation exchanger is amorphous titanosilicate (ATS), and the core particle is present in an amount of about 50 weight percent based on a total weight percent of the sorbent and the ceramic nanoparticulate cation exchanger is present in an amount of about 50 weight percent based on a total weight percent of the sorbent. In various non-limiting embodiments, all values and ranges of values, both whole and fractional, between and including those set forth above, are hereby expressly contemplated for use herein.

### Silica:

In addition to the above, the sorbent may include silica or be free of silica, such as fumed silica. The terminology “free of” typically describes embodiments that include less than 5, 4, 3, 2, 1, 0.5, 0.1, 0.05, or 0.01, weight percent of silica based on a total weight of the sorbent. Alternatively, the sorbent may be entirely free of silica, such as fumed silica (e.g., include zero weight percent of silica). In various non-limiting embodiments, all values and ranges of values, both whole and fractional, between and including those set forth above, are hereby expressly contemplated for use herein.

### Additional Embodiments

In various additional embodiments, the core particle may be described as a core or carrier and the ceramic nanoparticular cation exchanger may be described as a shell, thereby forming a shell-core or shell-carrier relationship. The core particle is typically a solid particle that does not form a gel mass. If the ceramic nanoparticular cation exchanger is or includes amorphous titanosilicate (ATS), then it is the ATS that can form a gel mass state and not the core particle. For example, the ATS in a gel mass state can stick to the core and then be dried before use.

In one embodiment, the carrier/core is not designed for and does not contribute to handling the sorbent. In other embodiments, the core can be any material that is (i) insoluble in water (ii) on NSF approval list and (iii) that to which the shell can adhere.

In still another embodiment, the core is not nanosized. For example, the sorbent may be described as being free of nanosized materials wherein the terminology “free of” is as described above.

In a further embodiment, the core particle may be selected such that it can adsorb oxyanions of arsenic, selenium, phosphate, etc. and combinations thereof.

### Method of Forming the Sorbent:

This disclosure also provides a method of forming the sorbent. The method includes providing a dispersion of the core particle and the ceramic nanoparticulate cation exchanger for at least one metal in water.

The dispersion is not particularly limited and may be any known in the art. Typically, the dispersion is formed in water but may be formed in another solvent combined with water, such as a polar solvent, alcohol, etc. The weight of the core particle and the ceramic nanoparticulate cation exchanger may be from about 0.01 to about 99.99 weight percent, based on a total weight of the dispersion. In various embodiments, the weight of the core particle and the ceramic nanoparticulate cation exchanger is from about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, or about 50, weight percent, based on a total weight of the dispersion. In various non-limiting embodiments, all values and ranges of values, both whole and fractional, between and including those set forth above, are hereby expressly contemplated for use herein.

The pH of the dispersion is greater than about 9.5, which may mean 9.5 exactly or about 9.5, e.g. ±0.05 In various embodiments, the pH may be about 9.6, 9.65, etc. up to about 14. In other embodiments, the pH is from about 9.6 to about 10, about 9.7 to about 9.9, or about 9.8 to about 9.9. In other embodiments, the pH is from about 10 to about 14, about 10.5 to about 13.5, about 11 to about 13, about 11.5 to about 12.5, or about 12 to about 12.5. In other examples, the pH is 9.6. At a pH of less than about 9.5, the dispersion tends to be unusable because it forms a pasty-mass, as further set forth in the Examples below. At a pH of greater than about 9.5, e.g. 9.6, a useable dispersion is formed.

The term “useable dispersion” typically describes that the dispersion has a viscosity of less than about 1000 cP as determined at 25° C. using a Brookfield viscometer. In other embodiments, this viscosity is from about 100 to about 1000, about 150 to about 950, about 200 to about 900, about 250 to about 850, about 300 to about 800, about 350 to about 750, about 400 to about 700, about 450 to about 650, about 500 to about 600, about 500 to about 500, about 400 to about 500, about 400 to about 450, about 450 to about 500, about 450 to about 475, or about 475 to about 500, 480 cP as determined at 25° C. using a Brookfield viscometer. The specifics of the Brookfield viscometer can be chosen by one of skill in the art. For example, these viscosities may be measured using the ASTM D2196 test method or a similar methodology. In various non-limiting embodiments, all values and ranges of values, both whole and fractional, between and including those set forth above, are hereby expressly contemplated for use herein.

Referring back, the method also includes the step of spray drying the dispersion to form the sorbent. The step of spray drying is not particularly limited and may be chosen by one of skill in the art. For example, spray drying is a method of producing a dry powder from a liquid or slurry (e.g. the aforementioned dispersion) by rapidly drying with a hot gas. Air is the heated drying medium but nitrogen can also be used. A spray drier includes an atomizer or spray nozzle to disperse the dispersion into a controlled drop size spray. The most common of these are rotary disk and single-fluid high pressure swirl nozzles. Atomizer wheels tend to provide broader particle size distribution, but both methods allow for consistent distribution of particle size. Two-fluid or ultrasonic nozzles can also be used. Drop sizes from about 10 to about 500 μm can be achieved with the appropriate parameter choices.

The spray drier may be a single effect spray drier wherein a single source of drying air at the top of a chamber is blown in the same direction as the sprayed dispersion. A fine powder is produced. A multiple effect spray drier can also be used. Instead of drying the dispersion in one stage, drying is done through two steps: the first at the top (as per single effect) and the second with an integrated static bed at the bottom of the chamber. The bed provides a humid environment which causes smaller particles to clump, producing more uniform particle sizes.

The powders generated by the first stage drying can be recycled in continuous flow either at the top of the chamber (around the sprayed dispersion) or at the bottom, inside an integrated fluidized bed. The drying of the powder can be finalized on an external vibrating fluidized bed. A hot drying gas can be passed in as a co-current fashion and in the same direction as a sprayed liquid atomizer, or as counter-current fashion wherein the hot drying gas flows against the flow from the atomizer. With co-current flow, particles spend less time in the system and a particle separator (typically a cyclone device). With counter-current flow, particles spend more time in the system and this flow is usually paired with a fluidized bed system. Co-current flow generally allows the system to operate more efficiently. One of skill in the art may choose which appropriate parameters to use in accordance with this disclosure to spray dry the dispersion to form the sorbent.

### Water Treatment Device:

This disclosure further provides a water treatment device that includes the sorbent. The water treatment device is not particularly limited and may be any known in the art including, but not limited to, filters. For example, the water treatment device may be a carbon block filters. Suitable carbon block filters that may be utilized in accordance with this disclosure include those described in U.S. Pat. Nos. 6,368,504 and 9,339,747, each of which is expressly incorporated herein in its entirety in various non-limiting embodiments. In other embodiments, the water treatment device may be a consumer water purification device such as a water pitcher, a refrigerator water filter, a drinking fountain, etc. It is contemplated that larger systems such as whole house water treatment systems or industrial sized water treatment systems may also utilize the technology of this disclosure.

### Method of Treating Water:

This disclosure further provides a method of treating water that includes at least one metal wherein the method includes the step of contacting the water with the sorbent. This method may utilize the aforementioned water treatment device. The step of contacting the water with the sorbent is not particularly limited and may be any known in the art.

### Additional Embodiments

In various additional embodiments, titanosilicate materials are very effective lead adsorbents and can be used in point of use drinking water applications such as in refrigerator filters and faucet mounted filters. During the normal lifecycle of a water filter, it is estimated that not more than 4% of the titanosilicate's adsorption capacity for lead is utilized, assuming ATS is 10% of a carbon block by weight, the influent concentration of lead is 50 ppb and saturation adsorption capacity of ATS is about 200 mg Pb/g ATS. Assuming all the adsorption then happens at the surface, a particle can be designed with the ceramic nanoparticulate cation exchanger coating on a core particle with a similar number of particles as ATS, as described herein. This means that it is now possible to achieve not only a more cost effective particle but also investment in new production capacity can be deferred.

As described herein, ATS can be coated on inexpensive core particles. A solid core particle, which may have porosity, such as those described above, can enable precipitation of an ATS gel thereon during spray drying. The solid core particle is typically easily be dispersed in a titanosilicate dispersion or gel.

### Examples

### Influence of pH on Sorbent Formation:

To evaluate an effect of pH on sorbent formation, a first series of sorbents is formed and evaluated, as set forth below. More specifically, dispersions of 50 wt % of amorphous titanosilicate (ATS) and 50 wt % of alumina are formed in water. The amorphous titanosilicate (ATS) is commercially available from Solenis LLC. The alumina is commercially available from Solenis LLC and has a D10 value of from about 4 to about 10, a D50 value of from about 10 to about 16, and a D90 value of from about 20 to about 42, micrometers, each determined using laser diffraction.

A first dispersion has a pH of about 8.5 and forms a thick pasty mass that cannot be easily pumped or spray dried. The thick pasty mass remains as the pH is raised from about 8.5 to about 9.5. Accordingly, this dispersion is not usable at a pH of about 9.5 or less.

A second dispersion has a pH of about 9.6 and does not form a pasty mass but instead has a viscosity of about 480 cP as determined at 25° C. using a Brookfield viscometer. This dispersion can be easily pumped and spray dried. Accordingly, this dispersion is usable.

### Influence of Spray Drying on Sorbent Formation:

To evaluate an effect of spray drying on sorbent formation, a second series of sorbents is also formed and evaluated, as also set forth below.

A third dispersion is formed that has a pH of about 9.6 and a viscosity of about 480 cP as determined at 25° C. using a Brookfield viscometer. This dispersion is mixed using a commercial mixer and is allowed to air dry at room temperature to form a powder.

A fourth dispersion is formed that has a pH of about 9.6 and a viscosity of about 480 cP as determined at 25° C. using a Brookfield viscometer. This dispersion is mixed using a commercial mixer and is spray dried using a laboratory spray drier as is understood in the art.

After formation, the powder formed from the third dispersion and the powder formed from the fourth dispersion are analyzed examined via x-ray photoelectron spectroscopy (XPS) to determine surface composition which is indicative of increased dispersion of the ATS and increased ATS coating of the alumina. In other words, the powders were evaluated to determine which powder had a more complete disposal of the ATS on the surface of the alumina, thereby indicating more efficient production and likely more efficient adsorption of heavy metals when later put in use.

As shown in Tables 1 and 2 below, the spray dried powder of Dispersion 4 has a lower Al₂O₃ surface concentration along with increased Na, TiSiO₄ (Si⁴⁺ and Ti⁴⁺), H₂O/OH and carbon concentrations as compared to the air dried powder of Dispersion 3. This is indicative of an increased dispersion of ATS in the spray dried powder of Dispersion 4 suggesting that the ATS better coated the alumina particles. Both powders contain similar amounts of Cl. The samples are measured at four separate 400 micron spots and the compositions are averaged and shown with a % StDev. The results for multiple spot measurements indicate that the samples are homogeneous. The first % StDev is the result of Monte Carlo simulations by fitting software. The second % StDev is a StDev of the average of four spot measurements. This comparison clearly shows significant enrichment of the surface of the spray dried powder with the ATS demonstrating efficient and effective formation of a coating of ATS on the alumina core. A particle size distribution of the spray dried powder is coarser than ATS indicating that the spray dry parameters (% solids and atomizer rpm can be adjusted to give a finer droplet size so that similar populations of spray dried powders per unit weight can also be used.

TABLE 1

| | Dispersion 3 | | Dispersion 3 | | Dispersion 3 | |
|---|---|---|---|---|---|---|
| | Spot #1 | | Spot #2 | | Spot #3 | |
| | | First | | First | | First |
| Compound | % | % StDev | % | % StDev | % | % StDev |
| Al₂O₃ | 34.1 | 0.2 | 32.8 | 0.2 | 33.7 | 0.2 |
| Adventitious | 3.5 | 0.1 | 3.9 | 0.1 | 3.4 | 0.1 |
| C—O, C═O | 1.6 | 0.1 | 2.0 | 0.1 | 1.9 | 0.1 |
| Cl/NaCl/C—Cl | 0.7 | 0.1 | 0.4 | 0.1 | 0.3 | 0.0 |
| Na | 1.0 | 0.0 | 1.0 | 0.0 | 0.9 | 0.0 |
| Oxide | 56.1 | 0.3 | 55.8 | 0.2 | 56.8 | 0.2 |
| H₂O/OH | 0.8 | 0.1 | 1.0 | 0.1 | 0.7 | 0.1 |
| SiO₂ | 1.5 | 0.2 | 2.0 | 0.2 | 1.4 | 0.2 |
| TiO₂ (4+) | 1.0 | 0.0 | 1.1 | 0.0 | 0.8 | 0.0 |
| Ti₂O₃ (3+) | 0.0 | 0.0 | 0.1 | 0.0 | 0.1 | 0.0 |
| Total | 1.0 | 0.0 | 1.2 | 0.0 | 0.9 | 0.0 |

| | |
|---|---|
| Dispersion 3 | |
| Spot #4 | Average |

| | | First | | Second |
|---|---|---|---|---|
| Compound | % | % StDev | % | % StDev |
| Al₂O₃ | 33.4 | 0.2 | 33.5 | 0.5 |
| Adventitious | 4.2 | 0.1 | 3.7 | 0.3 |
| C—O, C═O | 1.6 | 0.1 | 1.8 | 0.2 |
| Cl/NaCl/C—Cl | 0.3 | 0.0 | 0.4 | 0.2 |
| Na | 1.0 | 0.0 | 1.0 | 0.0 |
| Oxide | 54.9 | 0.2 | 55.9 | 0.7 |
| H₂O/OH | 1.9 | 0.1 | 1.1 | 0.5 |
| SiO₂ | 1.7 | 0.2 | 1.6 | 0.2 |
| TiO₂ (4+) | 1.0 | 0.0 | 1.0 | 0.1 |
| Ti₂O₃ (3+) | 0.1 | 0.0 | 0.1 | 0.0 |
| Total | 1.0 | 0.0 | 1.0 | 0.1 |

TABLE 2

| | Dispersion 4 | | Dispersion 4 | | | |
|---|---|---|---|---|---|---|
| | Spot #1 | | Spot #2 | | Dispersion 4 | |
| | | First | | First | Spot #3 | |
| Compound | % | % StDev | % | % StDev | % | % |
| Al₂O₃ | 21.8 | 0.3 | 21.2 | 0.3 | 21.4 | 0.3 |
| Adventitious | 5.5 | 0.1 | 6.0 | 0.1 | 6.0 | 0.1 |
| C—O, C═O | 3.4 | 0.1 | 2.8 | 0.1 | 3.4 | 0.2 |
| Cl/NaCl/C—Cl | 0.3 | 0.1 | 0.2 | 0.1 | 0.5 | 0.1 |
| Na | 3.0 | 0.1 | 3.2 | 0.0 | 3.1 | 0.0 |
| Oxide | 51.1 | 0.3 | 50.3 | 0.2 | 50.8 | 0.2 |
| H₂O/OH | 3.9 | 0.1 | 5.0 | 0.1 | 3.6 | 0.1 |
| SiO₂ | 6.8 | 0.2 | 6.9 | 0.2 | 6.9 | 0.2 |
| TiO₂ (4+) | 4.1 | 0.0 | 4.3 | 0.0 | 4.1 | 0.0 |
| Ti₂O₃ (3+) | 0.2 | 0.0 | 0.1 | 0.0 | 0.2 | 0.0 |
| Total | 4.2 | 0.0 | 4.4 | 0.0 | 4.3 | 0.0 |

Dispersion 4
Spot #4

| | |
|---|---|
| First | Average |

| Compound | % | % StDev | At % | % StDev |
|---|---|---|---|---|
| Al₂O₃ | 19.5 | 0.2 | 21.0 | 0.9 |
| Adventitious | 6.1 | 0.1 | 5.9 | 0.2 |
| C—O, C═O | 3.1 | 0.1 | 3.2 | 0.3 |
| Cl/NaCl/C—Cl | 0.0 | NA³ | 0.3 | 0.2 |
| Na | 3.6 | 0.1 | 3.2 | 0.2 |
| Oxide | 50.7 | 0.2 | 50.8 | 0.3 |
| H₂O/OH | 4.4 | 0.1 | 4.2 | 0.5 |
| SiO₂ | 7.7 | 0.2 | 7.1 | 0.4 |
| TiO₂ (4+) | 4.7 | 0.0 | 4.3 | 0.2 |
| Ti₂O₃ (3+) | 0.1 | 0.0 | 0.2 | 0.0 |
| Total | 4.8 | 0.0 | 4.4 | 0.2 |

### Evaluation of Particle Size:

To evaluate particle size, a third series of sorbents are formed and evaluated to determine D10, D50, and D90 values using laser diffraction. More specifically, the following sorbents are formed by forming dispersions having a pH of about 9.6 and spray drying, in the same method as described immediately above relative to Dispersion 4. The results are set forth in Table 3 below.

TABLE 3

| | Particle Size (μm) | | |
|---|---|---|---|
| Sample | d10 | d50 | d90 |
| Sample 1 - ATS alone - no alumina | 11.67 | 18.64 | 42.5 |
| Sample 2 - Alumina alone - no ATS | 1.086 | 3.66 | 10.56 |
| Sample 3 - 80 wt % alumina/20 wt % ATS | 4.61 | 10.1 | 20.52 |
| Sample 4 - 70 wt % alumina/30 wt % ATS | 6.78 | 12.69 | 24.45 |
| Sample 5 - 60 wt % alumina/40 wt % ATS | 6.91 | 14.05 | 25.13 |
| Sample 6- 50 wt % alumina/50 wt % ATS | 9.65 | 16.03 | 26.44 |
| Sample 7- 40 wt % alumina/60 wt % ATS | 8.14 | 15.19 | 41.6 |
| Sample 8- 30 wt % alumina/70 wt % ATS | 9.47 | 15.21 | 27.78 |
| Sample 9- 20 wt % alumina/80 wt % ATS | 8.26 | 13.39 | 23.78 |

This data shows that the sorbent tends not to overly agglomerate. Moreover, taken as a whole, the data above shows that an alumina core can be used in sorbent. Thus, the sorbent can be used remove oxyanions of Se or As or phosphate from water while ATS can also be used in a sorbent to remove lead and mercury from water.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A sorbent for at least one metal, said sorbent comprising:
a core particle; and
a ceramic nanoparticulate cation exchanger for at least one metal that is disposed about said core particle,
wherein said core particle is chosen from titanium dioxide, alumina, iron oxide, and combinations thereof.

2. The sorbent of claim 1 that is free of silica.

3. The sorbent of claim 1 wherein said core particle is alumina having a D10 value of from about 4 to about 10, a D50 value of from about 10 to about 16, and a D90 value of from about 20 to about 42, micrometers, each determined using laser diffraction.

4. The sorbent of claim 1 wherein said core particle is alumina having a D10 value, a D50 value, and a D90 value that are each independently of from about 1 to about 200, micrometers, each determined using laser diffraction.

5. The sorbent of claim 1 wherein said ceramic nanoparticulate cation exchanger is chosen from aluminosilicates, titanosilicates, and combinations thereof.

6. The sorbent of claim 1 wherein said ceramic nanoparticulate cation exchanger is amorphous titanosilicate (ATS).

7. The sorbent of claim 1 wherein said ceramic nanoparticulate cation exchanger is crystalline titanosilicate.

8. The sorbent of claim 1 wherein said core particle is present in an amount of from about 20 to about 80 weight percent based on a total weight percent of said sorbent and said ceramic nanoparticulate cation exchanger is present in an amount of from about 80 to about 20 weight percent based on a total weight percent of said sorbent.

9. The sorbent of claim 1 wherein said core particle is present in an amount of from about 30 to about 70 weight percent based on a total weight percent of said sorbent and said ceramic nanoparticulate cation exchanger is present in an amount of from about 70 to about 30 weight percent based on a total weight percent of said sorbent.

10. The sorbent of claim 1 wherein said core particle is present in an amount of from about 40 to about 60 weight percent based on a total weight percent of said sorbent and said ceramic nanoparticulate cation exchanger is present in an amount of from about 60 to about 40 weight percent based on a total weight percent of said sorbent.

11. The sorbent of claim 1 wherein said core particle is present in an amount of about 50 weight percent based on a total weight percent of said sorbent and said ceramic nanoparticulate cation exchanger is present in an amount of about 50 weight percent based on a total weight percent of said sorbent.

12. The sorbent of claim 1 wherein the at least one metal is lead,
wherein said core particle is alumina having a D10 value of from about 4 to about 10, a D50 value of from about 10 to about 16, and a D90 value of from about 20 to about 42, micrometers, each determined using laser diffraction;
wherein said ceramic nanoparticulate cation exchanger is amorphous titanosilicate (ATS); and
wherein said core particle is present in an amount of about 50 weight percent based on a total weight percent of said sorbent and said ceramic nanoparticulate cation exchanger is present in an amount of about 50 weight percent based on a total weight percent of said sorbent.

13. A method of forming a sorbent for at least one metal, said method comprising the steps of:
providing a dispersion of a core particle and a ceramic nanoparticulate cation exchanger for at least one metal in water, and
spray-drying the dispersion to form the sorbent,
wherein the dispersion has a pH of greater than about 9.5,
wherein the ceramic nanoparticulate cation exchanger is disposed about the core particle,
wherein the core particle is chosen from titanium dioxide, alumina, iron oxide, and combinations thereof.

14. The method of claim 13 wherein the sorbent is free of silica.

15. The method of claim 13 wherein the ceramic nanoparticulate cation exchanger is chosen from aluminosilicates, titanosilicates, and combinations thereof.

16. The method of claim 13 wherein the ceramic nanoparticulate cation exchanger is amorphous titanosilicate (ATS).

17. The method of claim 13 wherein the ceramic nanoparticulate cation exchanger is crystalline titanosilicate.

18. The method of claim 13 wherein the pH of the dispersion is about 9.6, wherein the dispersion has a viscosity of about 450 to about 500 cP determined at 25° C. using a Brookfield Viscometer, wherein the at least one metal is lead, wherein the core particle is alumina having a D10 value of from about 4 to about 10, a D50 value of from about 10 to about 16, and a D90 value of from about 20 to about 42, micrometers, each determined using laser diffraction; wherein the ceramic nanoparticulate cation exchanger is amorphous titanosilicate (ATS), and wherein the core particle is present in an amount of about 50 weight percent based on a total weight percent of the sorbent and the ceramic nanoparticulate cation exchanger is present in an amount of about 50 weight percent based on a total weight percent of the sorbent.

19. A water treatment device comprising the sorbent of claim 1.

20. A method of treating water comprising at least one metal, said method comprising the step of contacting the water with the sorbent of claim 1 to adsorb the metal from the water onto the sorbent.
